(19) United States
(12) Patent Application Publication
(10) Pub. No.: US 2026/0133537 A1
(43) Pub. Date: May 14, 2026

(54) BISTABLE ESCAPEMENT FOR A TIMEPIECE

(71) Applicant: James Seiner, Ann Arbor, MI (US)

(72) Inventor: James Seiner, Ann Arbor, MI (US)

(21) Appl. No.: 19/387,528

(22) Filed: Nov. 12, 2025

Related U.S. Application Data
(60) Provisional application No. 63/718,836, filed on Nov. 11, 2024.

(51) Int. Cl. G04B 15/14; G04B 15/08

(52) U.S. Cl. CPC G04B 15/14; G04B 15/08

(57) ABSTRACT

An escapement for a timepiece having a watch movement is disclosed. The watch movement includes a bistable escapement having a first pallet lever, a second pallet lever, and a flexible bistable portion connecting the first pallet lever to the second pallet lever and configured to bend and compress between watch movement impulses, wherein the flexible bistable portion comprises a first closed loop and a second closed loop within the first closed loop.

### CROSS REFERENCE TO RELATED APPLICATIONS

This application claims the benefit of Provisional Application No. 63/718,836 filed on Nov. 11, 2024 which is hereby incorporated herein by reference.

### TECHNICAL FIELD

This disclosure relates to timepiece movements, and more particularly to a bistable escapement for a timepiece.

### BACKGROUND

The statements in this section merely provide background information related to the present disclosure and may not constitute prior art.

An escapement is a mechanism in a timepiece which is placed between the escape wheel and an oscillator, i.e., a regulating member or balance wheel. There are many kinds of escapement mechanisms, including, e.g., a spring detent escapement and a pivoted detent escapement. The escapements are generally mechanically connected or coupled between the escape wheel and the oscillator to maintain motion of the oscillator. In operation, force is communicated from the escape wheel to the escapement and then to the oscillator at discrete time intervals. An escapement portion is a mechanical coupling that communicates the force from the escape wheel to the oscillator at discrete time intervals.

Watchmakers have designed many different escapements in efforts to improve mechanical efficiency, consistency of timekeeping, durability, service life, etc. The Swiss (or club-toothed) lever is ubiquitous in modern watches and combines good accuracy with simplicity and durability. The escapement portion in this escapement is a lever that is moved back and forth by the balance. This lever unlocks the escape wheel, then allows its tooth to slide along an impulse jewel, kicking the lever, and therefore the balance, the rest of the way. The process repeats each time the balance swings past its equilibrium point.

The Swiss lever however, is limited by the fact that impulse given to the balance is accomplished by a sliding motion. This sort of sliding motion is inefficient, resulting in a large change in the amplitude of the balance swing over the runtime of the watch, which impacts timing. It also requires oil on the escape wheel teeth, which degrades over the service life of the watch and impacts timing.

Hence, a need exists for an improved escapement for a timepiece.

### SUMMARY

An escapement for a timepiece having a watch movement is disclosed. The watch movement includes a bistable escapement having a first pallet lever, a second pallet lever, and a flexible bistable portion connecting the first pallet lever to the second pallet lever and configured to bend and compress between watch movement impulses, wherein the flexible bistable portion comprises a first closed loop and a second closed loop within the first closed loop.

The disclosure further includes an escapement for a timepiece having a watch movement which includes a bistable escapement having a first pallet lever including a first fork for selective engagement to mechanical elements coupled to a balance wheel, a second fork having an entry locking jewel configured to function as an entry pallet during operation, and a third fork having an impulse jewel configured to function as an exit pallet during operation, and a second pallet lever including a fourth fork having an entry locking jewel configured to function as a second entry pallet during operation, and a fifth fork having a second impulse jewel configured to function as an exit pallet during operation, and wherein the first pallet lever and the second pallet lever are connected via a flexible bistable portion configured to bend and compress between watch movement impulses.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIGS. 1A and 1B show an exemplary escapement for a watch movement in different states, in accordance with the present disclosure;

FIGS. 2A and 2B show an escapement portion of a watch escapement, in accordance with the present disclosure;

FIGS. 3A, 3B, and 3C show an embodiment of the escapement, in accordance with the present disclosure;

FIG. 3D illustrates a flexed position, in accordance with the present disclosure;

FIGS. 4A and 4B show an embodiment of the escapement, in accordance with the present disclosure;

FIGS. 5A and 5B show another embodiment of the escapement portion 10 and the flexible bistable portion, in accordance with the present disclosure;

FIGS. 6A-6D show an exemplary connection between a first pallet lever and a balance wheel, in accordance with the present disclosure; and

FIGS. 7A and 7B show an exemplary connection between a first pallet lever and a balance wheel at a different operating point than illustrated in FIGS. 6A-6D, in accordance with the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment. Similarly, the phrase “in some embodiments,” as used herein, when used multiple times, does not necessarily refer to the same embodiments, although it may.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

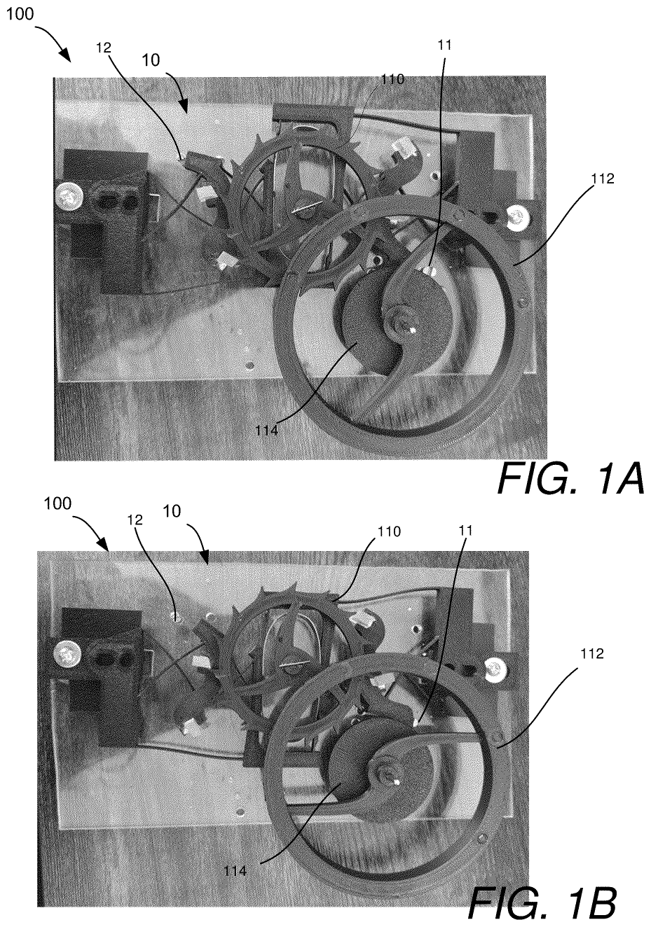

Referring now to the drawings, wherein the depictions are for the purpose of illustrating certain exemplary embodiments only and not for the purpose of limiting the same, FIGS. 1A and 1B show an exemplary escapement 100 that may be used in a watch movement. As FIGS. 1A and 1B show, the escapement 100 includes an escapement portion 10, an escape wheel 110, and a roller table 114. A balance wheel 112 is axially aligned with the roller table 114. The balance wheel 112 and the roller table 114 are preferably in fixed axial alignment, i.e., they do not rotate independently.

In some embodiments, the escapement 100 may include banking pins 11 and 12 to prevent over-rotation. The banking pins 11 and 12 may be eccentrically-shaped pins that may be affixed to the housing or a support plate therein. The banking pins 11 and 12 may be formed of brass or other similar rigid material. The banking pins 11 and 12 can limit over-rotation of the levers or escapement portion so that the jewel pallets remain in a desired position for engagement with the escape wheel 110 and the fork is in the correct position for engagement with the roller jewel. The eccentric shape allows for the spacing of the pins to be adjusted by rotating the pins in the plate. In some embodiments, the banking pins 11 and 12 may be half-round to accomplish the same goal (the lever can rotate further when engaging with the interior flat portion than with the exterior round portion).

The banking pins 11 and 12 can allow for “escapement draw,” which is the tendency of the lever to be actively pressed against the banking pin by the escape wheel forces in a Swiss lever, and by a combination of escape wheel forces and spring forces from the flexure design in my escapement. This “draw” makes it so that some amount force is required to move the locking jewel away from the escape wheel 110 so that it cannot accidentally partially unlock and cause an incomplete impulse, which would impact timing. In some embodiments, the banking pins 11 and 12 prevent the lever from moving too far in one direction by virtue of them being rigid, and also allow the force from the escape wheel 110 to prevent the lever from moving in the other direction. In this way, it is always in the same position when contacted by the balance wheel 112, which is necessary for the correct function of the escapement 100. For example, the banking pin 11 prevents undesirable movement by a first pallet lever 20, while the banking pin 12 prevents undesirable movement by a second pallet lever 40.

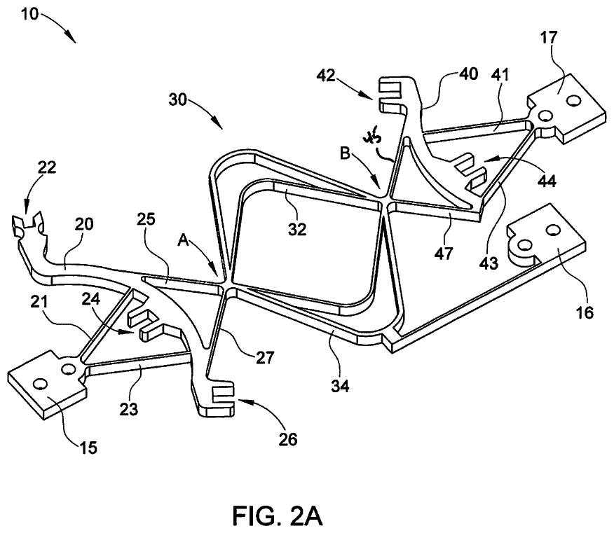

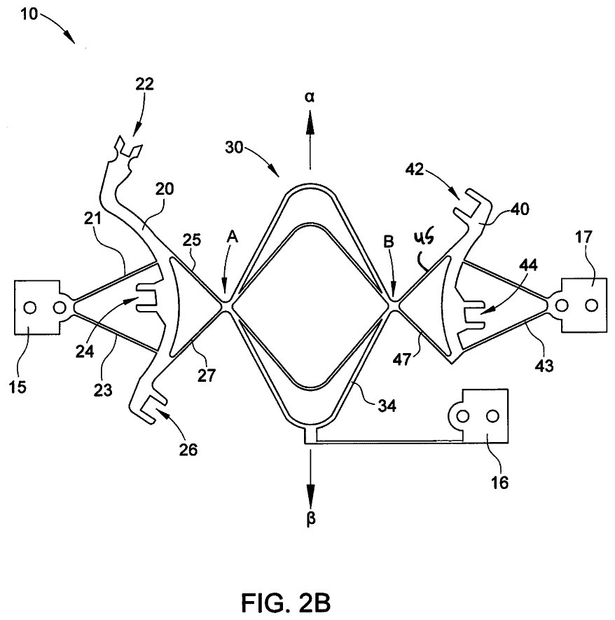

FIGS. 2A and 2B show an escapement portion 10 for an escapement 100. As FIGS. 2A and 2B show, the escapement portion 10 includes a first pallet lever 20, a second pallet lever 40, a flexible bistable portion 30, and one or more connecting elements, e.g., elements 15, 16, and 17.

The connecting elements, e.g., elements 15, 16, and 17, may be used to couple the escapement portion 10 to a housing, a movement plate, or another similarly fixed portion. The connecting elements may include one or more apertures to affix a mechanical connector, e.g., a bolt, a screw, a rivet, or the like therethrough and thereby secure the escapement portion 10.

The first pallet lever 20 includes a first fork 22 configured to selectively couple to mechanical elements associated with the balance wheel 112. A second fork 24 may be sized, shaped, and configured to receive a jewel pallet for engaging mechanical elements of the timepiece movement, e.g., an escape wheel 110. In some embodiments, the jewel pallet for the second fork 24 is configured to function as an exit pallet during operation. A third fork 26 is sized, shaped, and configured to receive a jewel pallet for engaging an escapement wheel 110. The jewel pallet for the third fork 26 is configured to function as an entry pallet during operation.

The first pallet lever 20 is coupled to an element fixed to a housing of the timepiece, a movement plate, or another similarly fixed, rigid portion, such as element 15. The first pallet lever 20 is coupled via elongated members 21 and 23. These elongated members 21 and 23 may be flexible, pliable members configured to bend or pivot. In some embodiments, the elongated members 21 and 23 are configured to selectively flex to the left and to the right.

The second pallet lever 40 includes a fourth fork 42 sized, shaped, and configured to receive a jewel pallet for engaging mechanical elements of the timepiece movement, e.g., the escape wheel 110. The jewel pallet for the fourth fork 42 is configured to function as an entry pallet during operation. A fifth fork 44 may be sized, shaped, and configured to receive a jewel pallet for engaging mechanical elements of the timepiece movement, e.g., the escape wheel 110. In some embodiments, the jewel pallet for the fifth fork 44 is configured to function as an exit pallet during operation.

The second pallet lever 40 is coupled to an element fixed to a housing of the timepiece, a movement plate, or another similarly fixed, rigid portion, such as element 17. The second pallet lever 40 is coupled via elongated members 41 and 43. These elongated members 41 and 43 may be flexible, pliable members configured to bend or pivot. In some embodiments, the elongated members 41 and 43 are configured to selectively flex to the left and to the right.

The flexible bistable portion 30 may be coupled to the first pallet lever 20 via one or more flexible elongated members. In some embodiments, an elongated member 25 and an elongated member 27 couple from the first pallet lever 20 to the flexible bistable portion 30.

The flexible bistable portion 30 may be coupled to the second pallet lever 40 via one or more flexible elongated members. In some embodiments, an elongated member 45 and an elongated member 47 couple from the second pallet lever 40 to the flexible bistable portion 30. In some embodiments, the flexible bistable portion 30 is preloaded, i.e., compressed along the direction perpendicular to alpha and beta in the neutral position.

In some embodiments, the one or more elongated members, e.g., members 25 and 27, couple to the flexible bistable portion 30 at an intersection point or portion, shown in FIG. 2B as ‘A’. Portion A may be an inflection point configured to aid bending of the escapement portion 10. In some embodiments, portion A is sized and shaped to bend along substantially one axis.

In some embodiments, the one or more elongated members, e.g., members 45 and 47, couple to the flexible bistable portion 30 at an intersection point or portion, shown in FIG. 2B as ‘B’. Portion B may be an inflection point configured to aid bending of the escapement portion 10. In some embodiments, portion B is sized and shaped to bend along substantially one axis.

As FIGS. 2A and 2B show, the flexible bistable portion 30 may include one or more concentric shaped elements configured to bend between impulses of the timepiece. In some embodiments, the flexible bistable portion 30 includes an inner closed loop element 32 and an outer closed loop element 34. In some embodiments, the flexible bistable portion 30 is sized and shaped to flex or bend along a single axis. That is, from the perspective of the top view shown in FIG. 2B, the flexible bistable portion 30 may translate substantially upward and downward as indicated by direction arrows ‘α’ and ‘β’, respectively. In some embodiments, when moving between impulses, the flexible bistable portion 30 will compress inward and outward, perpendicular to the directions ‘α’ and ‘β’.

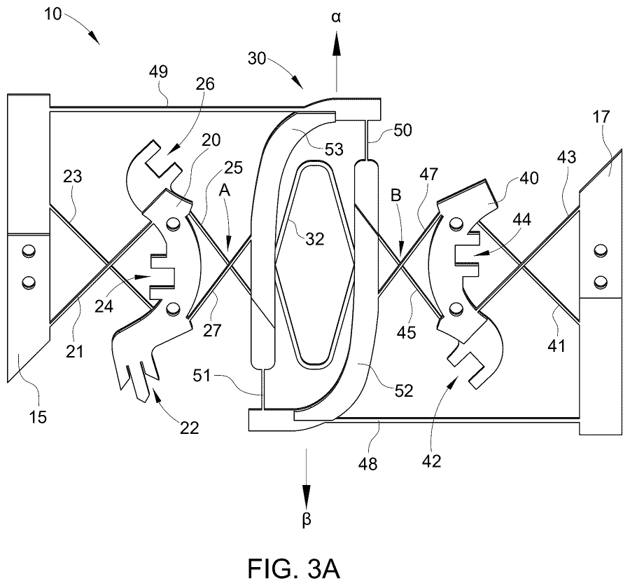

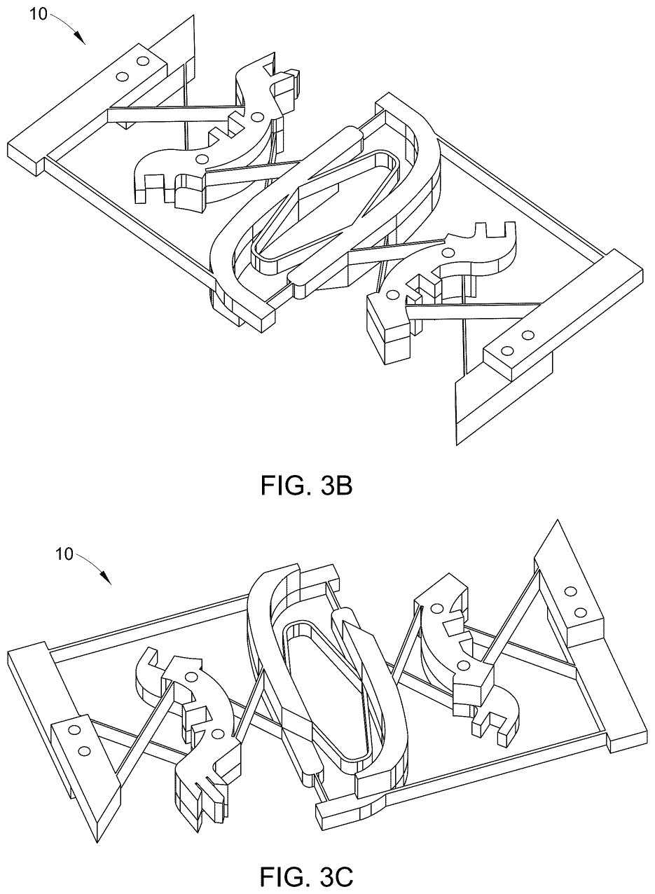

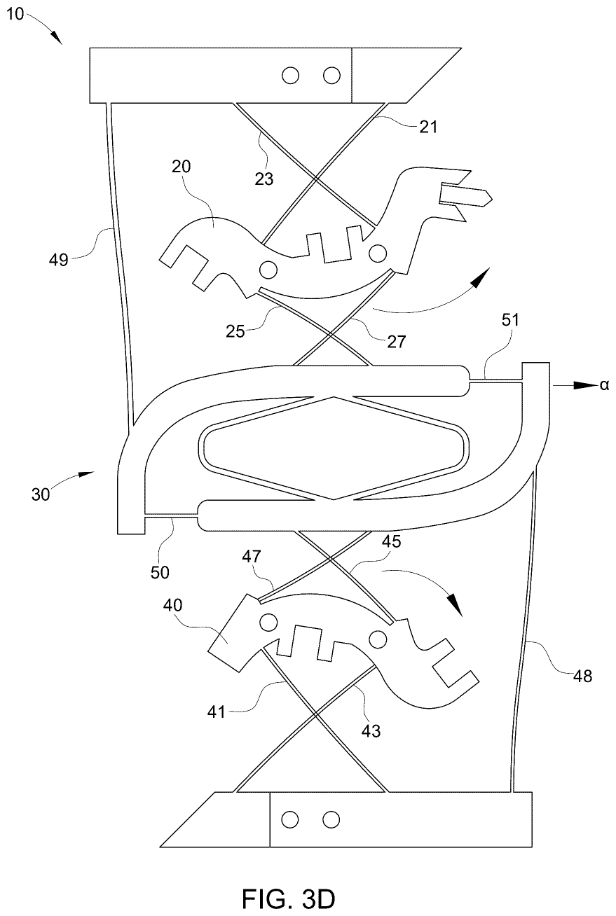

FIGS. 3A, 3B, and 3C show another embodiment of an escapement portion 10 for an escapement 100. As FIG. 3B, and 3C show, the flexible bistable portion 30 includes an inner closed loop element 32, and outer flexible members 48, 49, 50, and 51 and rigid members 52 and 53. In operation, flexible members 48 and 49 constrain the bistable portion 30 to translate parallel to ‘α’ and ‘β’, flexible members 50 and 51 communicate the force between the first fork 22 and the pallet jewels 64 and 66.

In some embodiments, rigid members 52 and 53 are J-shaped. Each rigid members 52 and 53 element includes a curved portion and a stem portion extending therefrom. The first J-shaped element is positioned in a standard orientation, while the second J-shaped element is inverted relative to the first, such that the concave portions of each face one another. A distal end of a stem of the first J-shaped rigid member, e.g., 52, are proximate to a curved portion of the second J-shaped rigid member, e.g., 53, and coupled via a flexible member 50. Likewise, a curved end of the first J-shaped rigid member 52 is proximate to the stem portion of the second J-shaped rigid member 53, and coupled via a flexible member 51. In this way, the rigid members 52 and 53 form an enclosed loop with a space between them. Within the enclosed loop the rigid members 52 and 53 may be joined by the inner closed loop element 32.

The inner closed loop element 32 may form a loop within the rigid members 52 and 53. In some embodiments, the inner closed loop element 32 is a closed loop which may be oval shaped, circular shaped, tear-drop shaped, egg-shaped. The inner closed loop element 32 has a continuous perimeter defining an elongated closed shape. As shown in FIGS. 3A-3D , the inner closed loop element 32 loop includes opposed arcuate end portions top and bottom portions integral with pairs of linear side portions that converge toward one another along the midsection of the loop to form a generally tapered profile. The arcuate end portions are smoothly contoured to transition into the adjacent linear side portions, thereby defining a continuous and uniform outer boundary. The inner boundary of the loop follows a substantially parallel path to the outer boundary, establishing a consistent wall thickness around the entire periphery.

In some embodiments, the inner closed loop element 32 is an elongated hexagonal-shaped aperture. In some embodiments, the inner closed loop element 32 is hexagonal-shaped, with the top and bottom sides being curved to transition into the adjacent linear side portions such as shown in FIGS. 3A-3D. In some embodiments, the adjacent linear side portions couple to the rigid members 52 and 53 at acute angles. In some embodiments, the inner closed loop element 32 is symmetrical about one axis. In some embodiments, the inner closed loop element 32 is symmetrical about two axes.

In some embodiments, the inner closed loop element 32 is formed of a resilient material configured to compress and depress between states of the escapement 100, i.e., between watch movement impulses. In some embodiments, the rigid members 52 and 53 and inner closed loop element 32 are integrally formed. In some embodiments the inner closed loop element 32 is not integral with the rigid members 52 and 53 but instead held in place via spring tension. In some embodiments, the inner closed loop element 32 is an integrally formed piece.

As FIGS. 3A, 3B, 3C and 3D show, members 25 and 27 cross over and under one another. Similarly, member 45 and 47 cross over and under one another. In this way, portions ‘A’ and ‘B’ of the embodiment shown in FIGS. 3A, 3B, 3C and 3D bend differently than portions ‘A’ and ‘B’ of the embodiment shown in FIGS. 2A and 2B.

FIG. 3D shows the escapement portion 10 in a flexed position. As FIG. 3D shows, flexible members 48, 49 bend toward the α direction, moving the flexible bistable portion 30. Elongated members 21, 23, 25, 27, 41, 43, 45, and 47 all bend toward the α direction. The inner closed loop element 32 will slightly compress in a direction perpendicular to the α direction. Outer flexible member 50 and 51 will slightly bend in a direction perpendicular to the α direction.

In some embodiments, the elongated members 21, 23, 25, 27, 41, 43, 45, and 47 and flexible members 48 and 49 will all have a rectangular cross-sectional-shape. As FIGS. 3A-3D show, a short side of the rectangular cross-sectional shape is oriented vertically and a long side oriented horizontally. The rectangular configuration defines orthogonal bending axes corresponding respectively to the vertical and horizontal dimensions of the cross section. When subjected to bending forces between states of the watch movement, the members are capable of flexural deflection in directions generally perpendicular to its longitudinal axis. Due to the differing second moments of area associated with the vertical and horizontal dimensions, the members exhibits greater bending compliance about its weak axis (corresponding to lateral side-to-side bending) and increased bending stiffness about its strong axis (corresponding to vertical bending). Thus, when the short side of the cross section is oriented upward, the elongated member bends more readily in a horizontal plane than in a vertical plane. Accordingly, when subject to bending, cross members 21 and 23 will bend and affect distance between fixed element 15 and pallet lever 20; cross members 25 and 27 will bend and affect distance between pallet lever 20 and rigid member 53; cross members 45 and 47 will bend and affect distance between rigid member 52 and pallet lever 40; and cross members 41 and 43 will bend and affect distance between pallet lever 40 and fixed element 17.

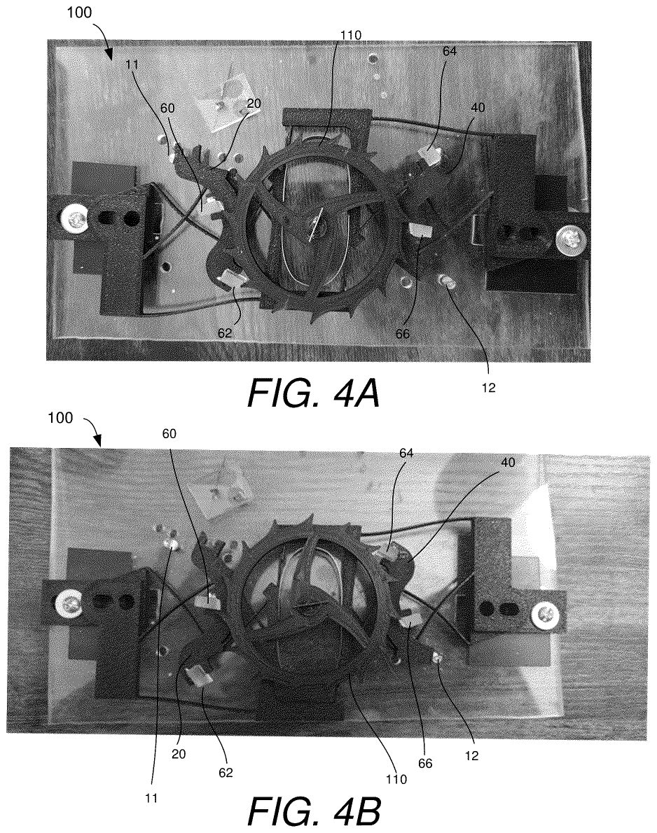

FIGS. 4A and 4B show an embodiment of the escapement 100. As FIGS. 4A and 4B show, the escapement 100 can include various impulse and locking jewels coupled to the forks of the pallet levers 20 and 40. An impulse jewel 60 may be coupled to the second fork 24, a locking jewel 62 may be coupled to the third fork 26, a locking jewel 64 may be coupled to the fourth fork 42, and an impulse jewel 66 may be coupled to the fifth fork 44, as shown.

As FIG. 4A shows, during operation, an escape wheel tooth has exited the locking pallet 64, engaged the impulse pallet 60, delivered impulse, and exited impulse pallet 60, engaged locking pallet 62. FIG. 4A shows the engagement of an escape wheel tooth with locking pallet 62 (this is not the same tooth that has done all this, but a tooth does each of these operations). An escape wheel tooth is positioned to engage with impulse pallet 66 once the escape wheel 110 is unlocked again.

As FIG. 4B shows, during operation, a tooth has exited the locking pallet 62, engaged the impulse pallet 66, delivered impulse, exited impulse pallet 66, engaged locking pallet 64, and is now positioned to engage the impulse pallet 60 once the escape wheel 110 is unlocked again. Upon release of the tooth, the escape wheel rotates, advancing the tooth. In this way, the escape wheel 110 advances discretely, in a tooth-by-tooth, manner.

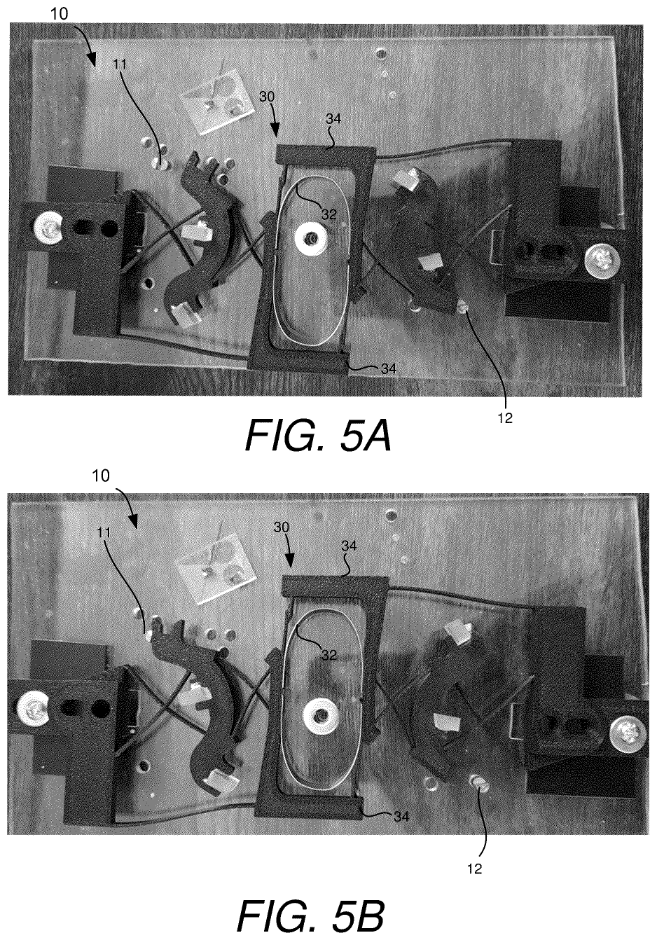

FIGS. 5A and 5B show another embodiment of the escapement portion 10 and the flexible bistable portion 30. As FIGS. 5A and 5B show, the inner closed loop element 32 and the outer closed loop element 34 of the flexible bistable portion 30 can be shaped differently. In some embodiments, the flexible bistable portion 30 is configured to compress inward and outward when the escapement 100 transitions between impulses, e.g., between the state shown in FIG. 5A and the state shown in FIG. 5B.

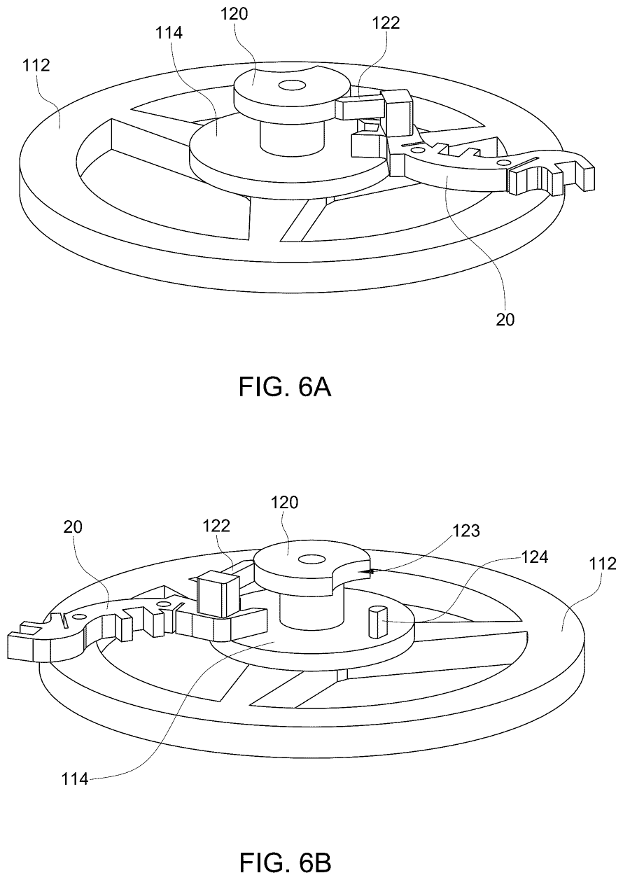

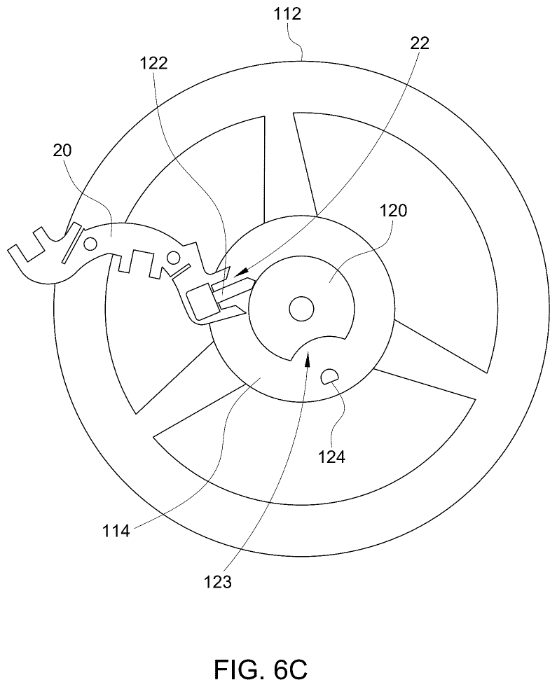

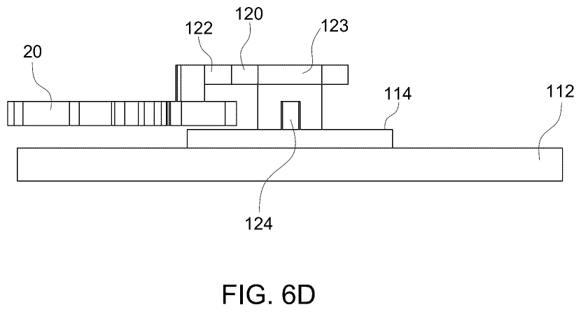

FIGS. 6A-6D show interactions between the first pallet lever 20 and the balance wheel 112. The balance wheel 112 is fixedly and axially coupled to the roller table 114 and the safety roller 120. As FIGS. 6A-6D show, the first pallet lever 20 is coupled to the safety pin 122 which, by selective interaction with the crescent-shaped cutout 123 of the safety roller 120, permits restrictive rotation of the first pallet lever 20 only when the roller jewel 124 abuts the first fork 22 of the first pallet lever 20. The roller jewel 124 is a protrusion of the roller table 114. When the roller table 114 rotates, the roller jewel 124 will move into forks of the first pallet lever 20, thereby pivoting the first pallet lever 20 and affecting interactions with the escape wheel 110.

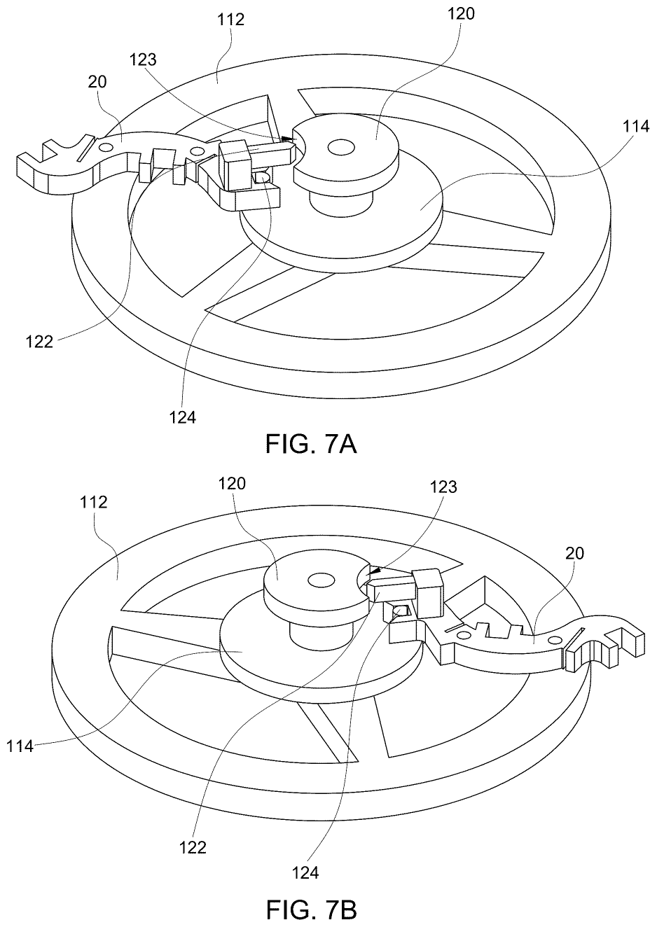

FIGS. 7A and 7B show the roller jewel 124 within the first fork 22 of the first pallet lever 20 and the safety pin 122 proximate to the crescent-shaped cutout 123 of the safety roller 120. The roller jewel 124 may be coupled to the roller table 114 using one of many known coupling techniques such as adhesive. In one embodiment, the roller table 114 has an opening configured to receive a portion of the roller jewel 124, which may then be inserted with adhesive.

Various components of the escapement portion 10 may be formed of plastic, glass, ceramics, fiber composites, metal (e.g., stainless steel, aluminum, metal alloys, etc.), other suitable materials, or a combination of these materials. In some situations, part or all of the escapement portion 10 may be formed from plastics or fiber composites having various rigidity or pliability properties as described hereinabove of the component. For rigid components, at least some may be formed from metal, glass, ceramic, sapphire, etc. or rigidly formed plastic or fiber composites. For pliable or flexible components metal alloys, silicon-based materials, plastic or fiber composites may primarily be used.

Additionally, examples in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

In the above description, certain terms may be used such as “upward,” “downward,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. Further, the term “plurality” can be defined as “at least two.”

As used herein, the term “or” is an inclusive “or” operator, and is equivalent to the term “and/or,” unless the context clearly dictates otherwise. The term “based, in part, on”, “based, at least in part, on”, or “based upon” is not exclusive and allows for being based on additional factors not described, unless the context clearly dictates otherwise.

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. A timepiece having a watch movement, comprising:
a bistable escapement having:
a first pallet lever;
a second pallet lever;
a flexible bistable portion connecting the first pallet lever to the second pallet lever and configured to bend and compress between watch movement impulses, wherein the flexible bistable portion comprises a first closed loop and a second closed loop within the first closed loop.

2. The timepiece of claim 1, wherein the flexible bistable portion comprises:
first and second elongated crossover members coupled to the first pallet lever and a first rigid loop portion;
third and fourth elongated crossover members coupled to the second pallet lever and a second rigid loop portion; and
wherein the first closed loop comprises the first and second rigid loop portions coupled together via first and second resilient members.

3. The timepiece of claim 2, wherein the first and second rigid loop portions of the first closed loop comprise an interior concavity, wherein the concavity is oriented to one another.

4. The timepiece of claim 2, wherein the first and second rigid loop portions of the first closed loop are further coupled together via the second closed loop.

5. The timepiece of claim 4, wherein the second closed loop is an integrally formed resilient member coupled to the first and second rigid loop portions at an acute angle.

6. The timepiece of claim 4, wherein the second closed loop is an integrally formed resilient member having two axes of symmetry.

7. The timepiece of claim 4, wherein the second closed loop is an integrally formed resilient member having an elongated hexagonal-shape with opposing top and bottom sides being curved to transition into adjacent sides.

8. The timepiece of claim 3, wherein the first rigid loop portion is coupled to a first fixed element via a first elongated flexible member to a side of the first rigid loop portion opposing the interior concavity thereof and wherein the second rigid loop portion is coupled to a second fixed element via a second elongated flexible member to a side of the second rigid loop portion opposing the interior concavity thereof.

9. The timepiece of claim 8, wherein the first fixed element is connected to the first pallet lever via fifth and sixth flexible crossover members, and wherein the second fixed element is connected to the second pallet lever via seventh and eight crossover members.

10. The timepiece of claim 8, wherein the first, second, third, fourth, fifth, sixth, seventh, and eight crossover members have a rectangular cross-sectional-shape configured to flex perpendicular to a long side of the rectangular cross-sectional-shape.

11. A timepiece having a watch movement, comprising:
a bistable escapement having:
a first pallet lever including a first fork for selective engagement to mechanical elements coupled to a balance wheel, a second fork having an entry locking jewel configured to function as an entry pallet during operation, and a third fork having an impulse jewel configured to function as an exit pallet during operation, and
a second pallet lever including a fourth fork having an entry locking jewel configured to function as a second entry pallet during operation, and a fifth fork having a second impulse jewel configured to function as an exit pallet during operation;
wherein the first pallet lever and the second pallet lever are connected via a flexible bistable portion configured to bend and compress between watch movement impulses, wherein the flexible bistable portion includes a first closed loop formed of alternating rigid and flexible members.

12. The timepiece of claim 11, wherein the flexible bistable portion further comprises:
first and second elongated crossover members coupled to the first pallet lever and a first rigid loop portion; and
third and fourth elongated crossover members coupled to the second pallet lever and a second rigid loop portion;
wherein the first and second rigid loop portions of the first closed loop comprise an interior concavity, wherein the concavity is oriented to one another; and
wherein the first and second rigid loop portions of the first closed loop are further coupled together via a second closed loop.

13. The timepiece of claim 12, wherein the second closed loop is an integrally formed resilient member coupled to the first and second rigid loop portions at an acute angle.

14. The timepiece of claim 12, wherein the second closed loop is an integrally formed resilient member having two axes of symmetry.

15. The timepiece of claim 12, wherein the second closed loop is an integrally formed resilient member having an elongated hexagonal-shape with opposing top and bottom sides being curved to transition into adjacent sides.

16. The timepiece of claim 15, wherein the first rigid loop portion is coupled to a first fixed element via a first elongated flexible member to a side of the first rigid loop portion opposing the interior concavity thereof and wherein the second rigid loop portion is coupled to a second fixed element via a second elongated flexible member to a side of the second rigid loop portion opposing the interior concavity thereof.

17. The timepiece of claim 16, wherein the first fixed element is connected to the first pallet lever via fifth and sixth flexible crossover members, and wherein the second fixed element is connected to the second pallet lever via seventh and eight crossover members and, wherein the first, second, third, fourth, fifth, sixth, seventh, and eight crossover members have a rectangular cross-sectional-shape configured to flex perpendicular to a long side of the rectangular cross-sectional-shape.

18. A timepiece having a watch movement, comprising:
a bistable escapement having:
a first pallet lever including a first fork for selective engagement to mechanical elements coupled to a balance wheel, a second fork having an entry locking jewel configured to function as an entry pallet during operation, and a third fork having an impulse jewel configured to function as an exit pallet during operation, and
a second pallet lever including a fourth fork having an entry locking jewel configured to function as a second entry pallet during operation, and a fifth fork having a second impulse jewel configured to function as an exit pallet during operation; and
a flexible bistable portion connecting the first pallet lever to the second pallet lever and configured to bend and compress between watch movement impulses, wherein the flexible bistable portion comprises a first closed loop and a second closed loop within the first closed loop, wherein the first closed loop is formed of alternating rigid and flexible members, and wherein the second closed loop is coupled to the rigid members of the first closed loop.

19. The timepiece of claim 18, wherein the flexible bistable portion further comprises:
first and second elongated crossover members coupled to the first pallet lever and a first rigid loop portion of the first closed loop;
third and fourth elongated crossover members coupled to the second pallet lever and a second rigid loop portion of the first closed loop; and
wherein the first and second rigid loop portions of the first closed loop comprise an interior concavity, wherein the concavity is oriented to one another and defines a space to encompass the second closed loop.

20. The timepiece of claim 19, wherein the second closed loop is an integrally formed resilient member having an elongated hexagonal-shape with opposing top and bottom sides being curved to transition into adjacent sides.

21. The timepiece of claim 20, wherein the first rigid loop portion is coupled to a first fixed element via a first elongated flexible member to a side of the first rigid loop portion opposing the interior concavity thereof and wherein the second rigid loop portion is coupled to a second fixed element via a second elongated flexible member to a side of the second rigid loop portion opposing the interior concavity thereof;
wherein the first fixed element is connected to the first pallet lever via fifth and sixth flexible crossover members, and wherein the second fixed element is connected to the second pallet lever via seventh and eight crossover members; and
wherein the first, second, third, fourth, fifth, sixth, seventh, and eight crossover members have a rectangular cross-sectional-shape configured to flex perpendicular to a long side of the rectangular cross-sectional-shape.
